(19) United States
(12) Patent Application Publication
(10) Pub. No.: US 2015/0354459 A1
(43) Pub. Date: Dec. 10, 2015

(54) FUEL INJECTOR FOR HIGH ALTITUDE STARTING AND OPERATION OF A GAS TURBINE ENGINE

(71) Applicant: Hamilton Sundstrand Corporation, Windsor Locks, CT (US)

(72) Inventors: Daih-Yeou Chen, San Diego, CA (US); Xiaolan Hu, San Diego, CA (US); James Peffley, San Diego, CA (US); Hanjie Lee, San Diego, CA (US)

(21) Appl. No.: 14/764,469

(22) PCT Filed: Jan. 30, 2014
(86) PCT No.: PCT/US14/13864

§ 371 Date: Jul. 29, 2015

Related U.S. Application Data
(60) Provisional application No. 61/759,786, filed on Feb. 1, 2013.

(51) Int. Cl. F02C 7/26; F23R 3/28

(52) U.S. Cl. CPC F02C 7/26; F23R 3/28

(57) ABSTRACT

A fuel injector for a combustor of a gas turbine engine includes an air swirler adjacent to a pressure atomizer.

This application claims priority to U.S. Patent Appin. No. 61/759,786 filed Feb. 1, 2013.

### BACKGROUND

The present disclosure relates to a gas turbine engine and, more particularly, to a fuel injector therefor.

An auxiliary power unit (APU) is commonly installed in aircraft and vehicles to provide mechanical, electrical and pneumatic power. The APU often provides power and/or compressed air for such tasks as environmental control, lighting, electrical systems, main engine starting, etc.

In some instances the APU may be started at relatively high altitudes. Since air density is quite low at high altitudes, fuel required to start and operate the APU becomes relatively low and difficult to pressurize such that fuel pressure alone may not be sufficient for atomization with relatively cold fuel.

### SUMMARY

A fuel injector for a combustor of a gas turbine engine according to one disclosed non-limiting embodiment of the present disclosure includes an air swirler adjacent to a pressure atomizer.

A further embodiment of the present disclosure includes, wherein the air swirler directs airflow at about a thirty (30) degree angle with respect to a fuel injector body of the fuel injector.

A further embodiment of any of the foregoing embodiments of the present disclosure includes, wherein the air swirler directs airflow at about a zero (0) degree angle with respect to a fuel injector body of the fuel injector

A further embodiment of any of the foregoing embodiments of the present disclosure includes, wherein the air swirler provides less than approximately 20% of primary zone air.

A further embodiment of any of the foregoing embodiments of the present disclosure includes, wherein the air swirler is mounted within an air shroud mounted to a combustor case.

A further embodiment of any of the foregoing embodiments of the present disclosure includes, wherein the air swirler surrounds the pressure atomizer.

A further embodiment of any of the foregoing embodiments of the present disclosure includes, wherein the gas turbine engine is an Auxiliary Power Unit (APU).

An auxiliary power unit, according to another disclosed non-limiting embodiment of the present disclosure includes an air shroud mounted with a fuel injector body that extends at least partially into the air shroud. A pressure atomizer mounted to the fuel injector body and an air swirler mounted adjacent to the air shroud to at least partially surround the pressure atomizer.

A further embodiment of any of the foregoing embodiments of the present disclosure includes, wherein the air shroud and the fuel injector body defines an annular airflow path

A further embodiment of any of the foregoing embodiments of the present disclosure includes, wherein the air swirler directs airflow at about a thirty (30) degree angle with respect to the fuel injector body.

A further embodiment of any of the foregoing embodiments of the present disclosure includes, wherein the air swirler directs airflow at about a zero (0) degree angle with respect to the fuel injector body.

A further embodiment of any of the foregoing embodiments of the present disclosure includes, wherein the pressure atomizer defines an angle with respect to a fuel injector body.

A further embodiment of any of the foregoing embodiments of the present disclosure includes, wherein the pressure atomizer is directed toward a dome of the combustor liner.

A method of starting an Auxiliary Power Unit (APU) according to another disclosed non-limiting embodiment of the present disclosure includes injecting fuel into the APU at least partially by pressure atomization in response to the APU being below an altitude threshold; and injecting fuel into the APU at least partially by airblast atomization in response to the APU being above the altitude threshold.

A further embodiment of any of the foregoing embodiments of the present disclosure includes, wherein the altitude threshold is about 45,000 feet.

A further embodiment of any of the foregoing embodiments of the present disclosure includes swirling an airflow.

A further embodiment of any of the foregoing embodiments of the present disclosure includes igniting the fuel to start the APU.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic partial cross-sectional view of a gas turbine engine disclosed herein as an Auxiliary Power Unit (APU), in an embodiment;

FIG. 2 is an expanded cross-sectional view of a combustor section, in an embodiment;

FIG. 3 is an expanded schematic cross-sectional view of a fuel injector according to one disclosed non-limiting embodiment, in an embodiment;

FIG. 4 is a schematic view of a relatively low altitude pressure atomization of the air blast fuel injector, in an embodiment;

FIG. 5 is a schematic view of a relatively high altitude air blast atomization of the fuel injector, in an embodiment;

FIG. 6 is an expanded cross-sectional view of air swirler according to an embodiment; and

FIG. 7 is an expanded cross-sectional view of an air swirler according to another embodiment.

### DETAILED DESCRIPTION

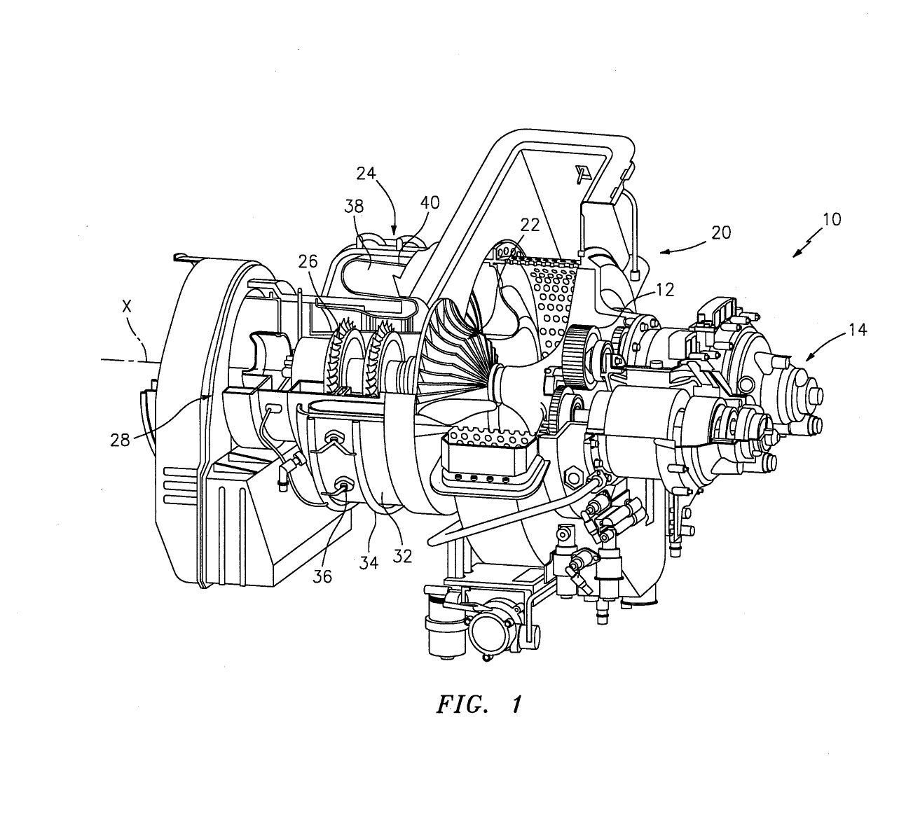

FIG. 1 schematically illustrates a gas turbine engine 10 disclosed herein as an Auxiliary Power Unit (APU), however various gas turbine engines may also benefit herefrom. The gas turbine engine 10 includes an inlet section 20, a compressor section 22, a combustor section 24, a turbine section 26 and an exhaust section 28 circumferentially disposed about an engine centerline X. It should be appreciated that various other components and sections may alternatively or additionally be provided for this or other engine architectures.

In operation, air is drawn through the inlet section 20, pressurized by the compressor section 22 then mixed with fuel and burned in the combustion section 24. The products of combustion that are expanded through the turbine section 26 above an idle fuel flow rate develop more power than needed to drive the compressor section 22 such that some air (often referred to as “bleed air”) can be drawn off and used as a pneumatic output to power other devices. Alternatively, the power can be used to drive a load compressor that compresses air in a separate stage, drives other systems, or provides combinations thereof. Furthermore, the gas turbine engine 10 may alternatively or additionally drive a gearbox 12 to rotate one or more generators 14 and, for example, provide electrical power.

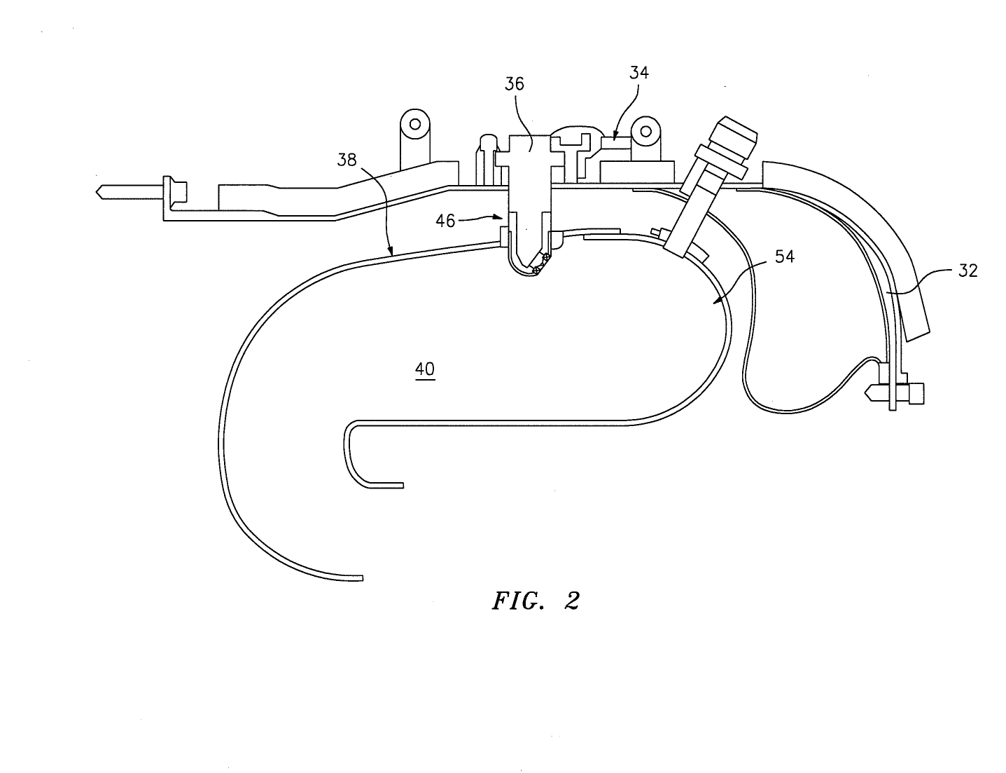

With reference to FIG. 2, the combustion section 24 generally includes a combustor case 32 that supports a fuel manifold 34 with a multiple of fuel injectors 36 in communication with a combustor liner 38 contained within the combustor case 32. The combustor liner 38 establishes a combustion area 40 in which the multiple of fuel injectors 36 inject fuel for mixture with air. The multiple of fuel injectors 36 are located circumferentially around and through the combustor case 32 to inject fuel under pressure into the combustion area 40 for ignition.

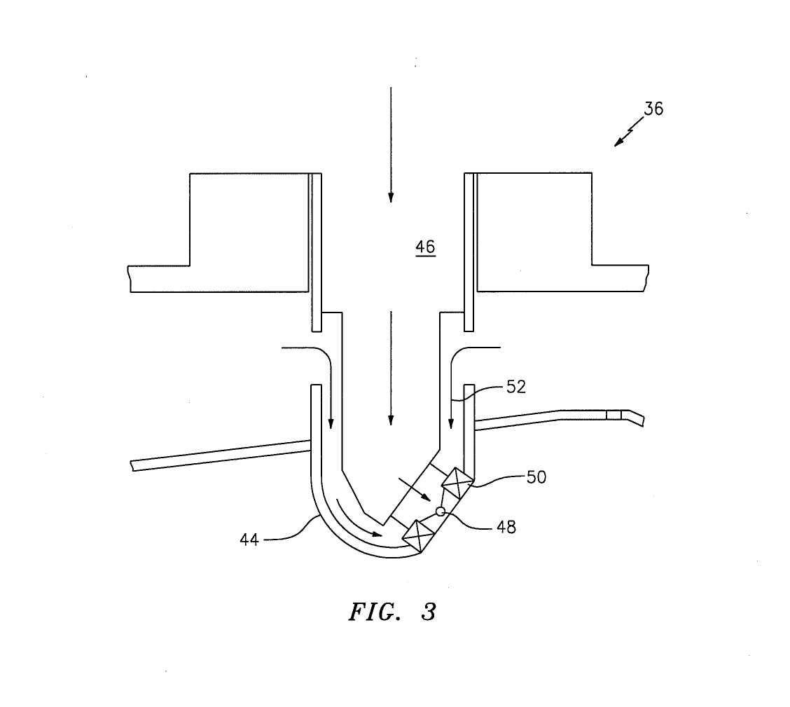

With reference to FIG. 3, one or more of the fuel injectors 36 may be a pilot (start) fuel injector. That is, one or more of the multiple of fuel injectors 36 may generally include an air shroud 44, a fuel injector body 46, a pressure atomizer 48 and an air swirler 50. The air shroud 44 is mounted in the combustor liner 38 such that the fuel injector body 46 is mounted therethrough to define an annular airflow path 52. The air swirler 50 is mounted in the air shroud 44 or an integral part of the injector body to surround the pressure atomizer 48. The pressure atomizer 48 defines a fuel injection tip of the fuel injector body 46 from which fuel is injected under a defined pressure. The pressure atomizer 48 may be angled with respect to the fuel injector body 46 to direct the fuel into a primary zone, for example, toward a dome 54 (FIG. 2) of the combustion area 40.

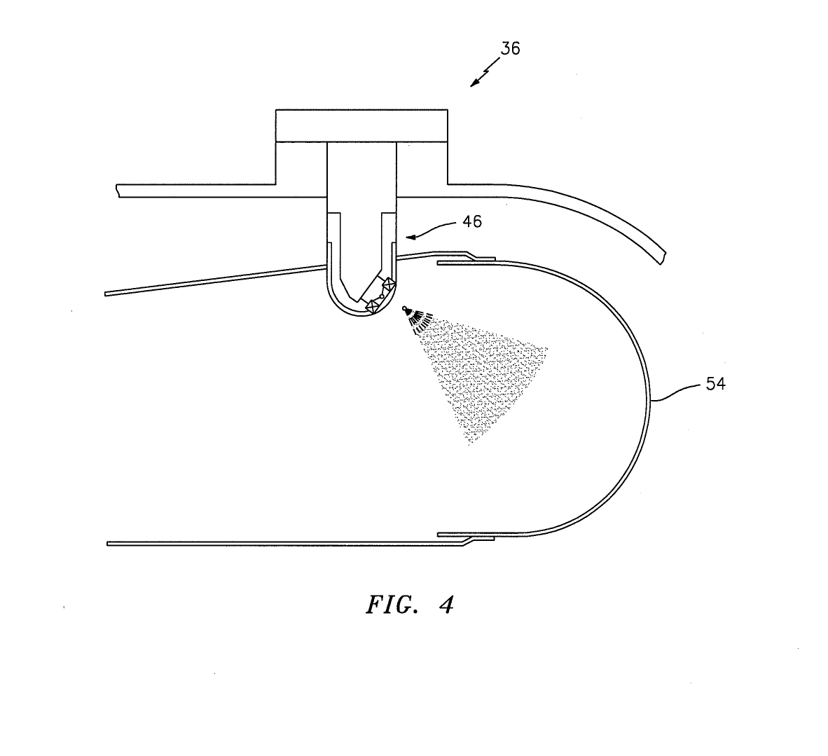

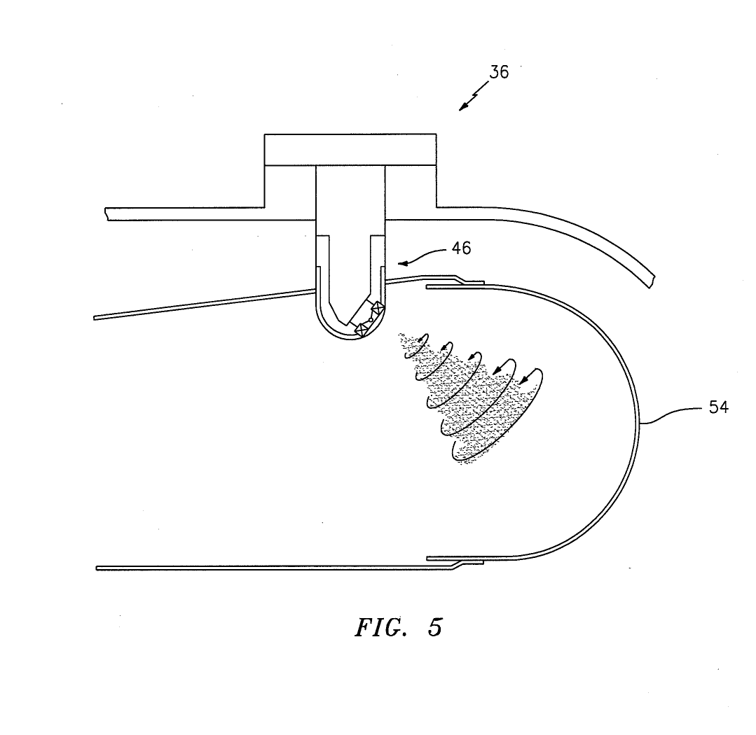

In an embodiment, the air swirler 50 injects or blasts air tangentially into the combustion area 40 primary zone. The air swirler 50 provides less than approximately 20% of primary zone air to minimize impact on the primary zone flow pattern. On the ground or at relatively lower altitudes, the fuel injectors 36 utilize pressure atomization (FIG. 4; illustrated schematically) to inject pilot (start) fuel into the primary zone of the combustion area 40 through the pressure atomizer 48 to mix with air for engine light-off and engine start. That is, on the ground or at relatively low altitudes, the available fuel pressure and relatively high air density is sufficient for the fuel injectors 36 to provide pressure atomization since the minimum light-off and start fuel flows are relatively high. Since the fuel flow momentum from the high fuel pressure atomization is much higher than the airflow momentum from the air swirler, the air discharged from the air swirler will not have negative impact on fuel spray for light-off and starting at relatively lower altitudes. At relatively high altitudes, pilot fuel pressure is not available and the fuel injectors 36 utilize airblast atomization (FIG. 5; illustrated schematically) through the air swirler 50 to mix air with pilot (start) fuel. Test data has shown that the fuel injectors 36 are readily capable of reliable light-off, start and engine operation at 45,000+feet altitudes. That is, to ensure reliable start and stable engine operation at relatively high altitudes and relatively low air density, the air swirler 50 facilitates fuel atomization for light-off and starting.

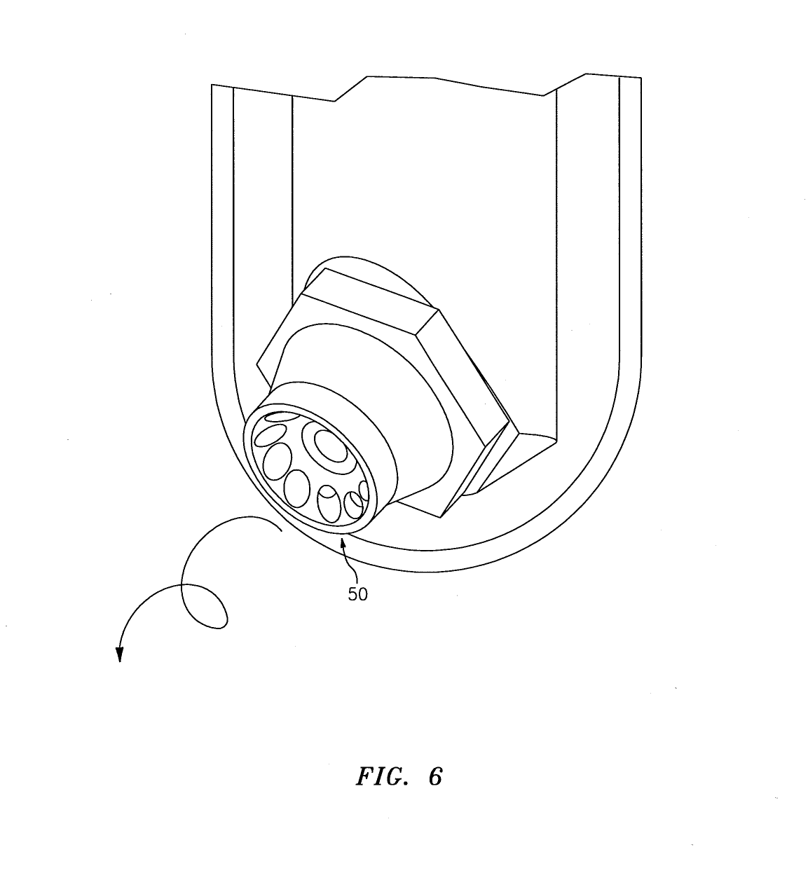

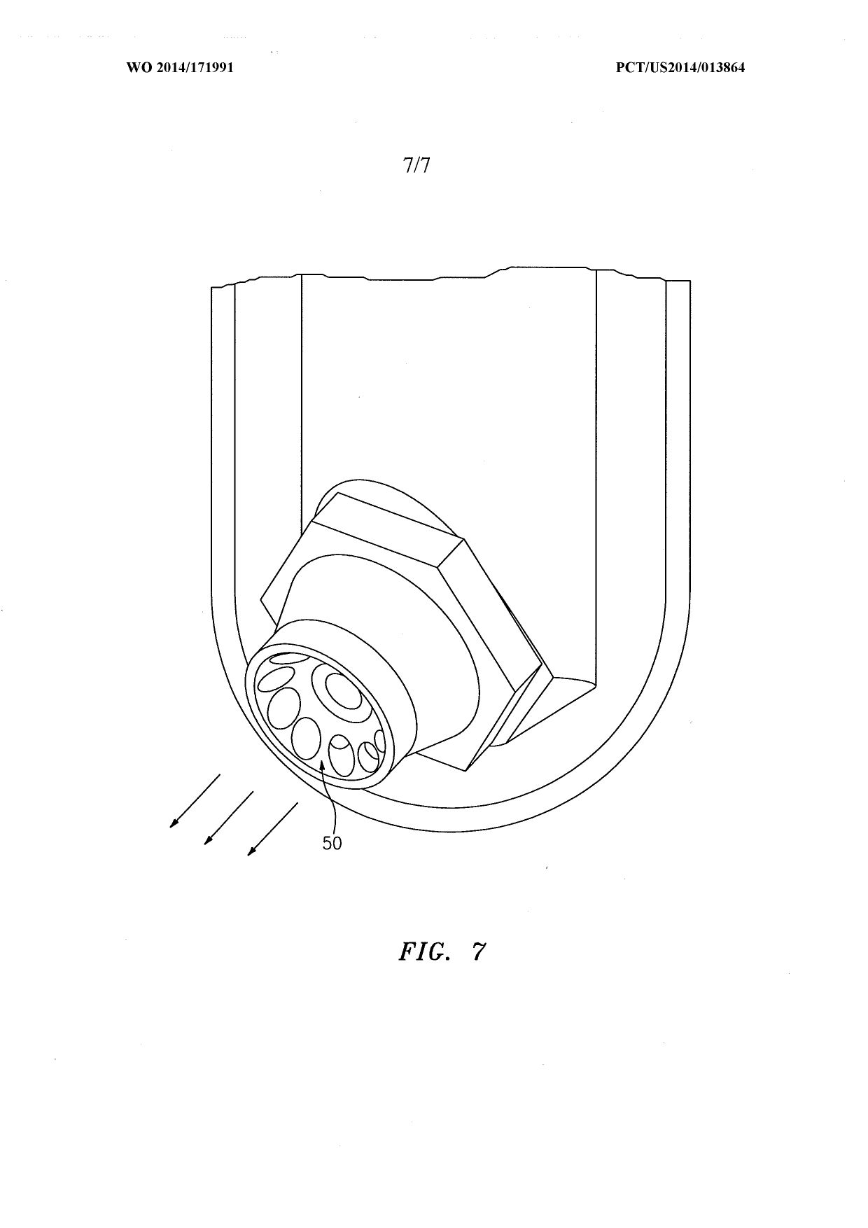

For airblast atomization, the air swirler 50 swirls the airflow tangentially into the primary zone of the combustion area 40 with less than approximately 20 percent of primary zone air to minimize impact on the primary zone airflow pattern at, in one disclosed non-limiting embodiment, a thirty (30) degree angle (FIG. 6). That is, by directing the airflow form the air swirler 50 at, for example, the thirty (30) degree angle, the fuel-air mixture of the primary zone airflow pattern is minimally impacted. The thirty (30) degree angle is generally with respect to the fuel injector 36. In another disclosed non-limiting embodiment, a zero (0) degree angle (FIG. 7) provides an airblast to facilitate atomization of the fuel but may not specifically swirl the airflow.

Two modes of fuel atomization are thereby provided, i.e., pressure atomization, and airblast atomization. At relatively high altitudes, air pressure, instead of fuel pressure, atomizes the fuel. After light-off, engine speed increases and the air pressure drop across the air swirler also increases to further facilitates fuel atomization. Advantageously, the volume of well-atomized pilot (start) fuel may be reduced for increased flame propagation and to minimize the potential of flameouts caused by poor atomization and too much fuel during high altitude start.

It should be understood that like reference numerals identify corresponding or similar elements throughout the several drawings. It should also be understood that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. A fuel injector for a combustor of a gas turbine engine comprising:
a pressure atomizer; and
an air swirler adjacent to said pressure atomizer.

2. The fuel injector as recited in claim 1, wherein said air swirler directs airflow at about a thirty (30) degree angle with respect to a fuel injector body of said fuel injector.

3. The fuel injector as recited in claim 1, wherein said air swirler directs airflow at about a zero (0) degree angle with respect to a fuel injector body of said fuel injector

4. The fuel injector as recited in claim 1, wherein said air swirler provides less than approximately 20% of primary zone air.

5. The fuel injector as recited in claim 1, wherein said air swirler is mounted within an air shroud mounted to a combustor case.

6. The fuel injector as recited in claim 1, wherein said air swirler surrounds said pressure atomizer.

7. The fuel injector as recited in claim 1, wherein said gas turbine engine is an Auxiliary Power Unit (APU).

8. An auxiliary power unit, comprising:
an air shroud;
a fuel injector body that extends into said air shroud;
a pressure atomizer mounted to said fuel injector body; and
an air swirler mounted adjacent to said air shroud to at least partially surround said pressure atomizer.

9. The auxiliary power unit as recited in claim 8, wherein said air shroud and said fuel injector body defines an annular airflow path

10. The auxiliary power unit as recited in claim 8, wherein said air swirler directs airflow at about a thirty (30) degree angle with respect to said fuel injector body.

11. The auxiliary power unit as recited in claim 8, wherein said air swirler directs airflow at about a zero (0) degree angle with respect to said fuel injector body.

12. The auxiliary power unit as recited in claim 8, wherein said pressure atomizer defines an angle with respect to a fuel injector body.

13. The auxiliary power unit as recited in claim 12, wherein said pressure atomizer is directed toward a dome of said combustor liner.

14. A method of starting an Auxiliary Power Unit (APU) comprising:
injecting fuel into the APU at least partially by pressure atomization in response to the APU being below an altitude threshold; and
injecting fuel into the APU at least partially by airblast atomization in response to the APU being above the altitude threshold.

15. The method as recited in claim 14, wherein the altitude threshold is about 45,000 feet.

16. The method as recited in claim 14, further comprising swirling an airflow.

17. The method as recited in claim 14, further comprising igniting the fuel to start the APU.
